(19) United States
(12) Patent Application Publication
(10) Pub. No.: US 2017/0316595 A1
(43) Pub. Date: Nov. 2, 2017

(54) METHOD FOR PROVIDING RIGGING TOOL AND APPARATUS FOR PROVIDING RIGGING TOOL

(71) Applicant: KOREA ADVANCED INSTITUTE OF SCIENCE AND TECHNOLOGY, Daejeon (KR)

(72) Inventors: Jun Yong Noh, Daejeon (KR); Seung Bae Bang, Daejeon (KR); Byung Kuk Choi, Daejeon (KR); Roger Blanco Ribera, Daejeon (KR); Mee Kyoung Kim, Daejeon (KR); Sung Hee Lee, Daejen (KR)

(21) Appl. No.: 15/203,459

(22) Filed: Jul. 6, 2016

(30) Foreign Application Priority Data
Apr. 28, 2016 (KR) 10-2016-0052406

(51) Int. Cl. G06T 13/40

(52) U.S. Cl. CPC G06T 13/40; G06T 2207/20044

(57) ABSTRACT

Disclosed is a method for providing a rigging tool. The method for providing a rigging tool includes receiving an input character, generating a basic rigging at the input character by using a skeleton extraction technique and a skinning weight technique, and providing a skeleton correction function and a skinning weight correction function on the basis of the generated basic rigging.

### CROSS-REFERENCE TO RELATED APPLICATION

This application claims priority of Korean Patent Application No. 10-2016-0052406, filed on Apr. 28, 2016, in the KIPO (Korean Intellectual Property Office), the disclosure of which is incorporated herein entirely by reference.

### BACKGROUND OF THE INVENTION

### Field of the Invention

In order to put an animation on a virtual character, a rigging process is required. Here, the rigging is defined as defining elements of a motion of a character, setting a boundary, and serving as an interface for applying an animation to an animator, and enriched expression of a character may depend on rigging.

However, in order to generate a rigging, long-term working hours are demanded to skilled animators and skilled artists in the existing technique, and it is difficult for a general user to generate and correct a rigging.

### Description of the Related Art

This disclosure is directed to providing a method for providing a rigging tool, which may generate a basic rigging of a character and give a skeleton correction function and a skinning weight correction function for the generated basic rigging.

### SUMMARY OF THE INVENTION

In one general aspect, there is provided a method for providing a rigging tool, which comprises: receiving an input character; generating a basic rigging at the input character by using a skeleton extraction technique and a skinning weight technique; and providing a skeleton correction function and a skinning weight correction function on the basis of the generated basic rigging.

Here, the skeleton extraction technique may generate a skeleton by compressing the input character into a zero volume and erasing a face.

Here, the skeleton extraction technique may remove unnecessary portions from the generated skeleton by using a Douglas-Peucker algorithm.

In addition, the skinning weight technique may calculate a skinning weight by using an equation (H−L)wⁱ=Hpⁱ, where L is a Laplacian matrix, H is a heat contribution matrix, w is a weight vector, and p is a binary number.

In addition, the skinning weight technique may calculate a skinning weight by using a local computing region which calculates only a partial region of the character.

Here, the skinning weight technique may calculate a skinning weight by using an equation B(H−L)Awⁱ+B(H−L)B^{T}wⁱ=Hpⁱ, where L is a Laplacian matrix, H is a heat contribution matrix, w is a weight vector, p is a binary number, B is a matrix clipping computing vertices, and A is a matrix clipping non-computing vertices.

In addition, the providing of a skinning weight correction function may provide a skinning weight correction function by using at least one function selected from the group consisting of a weight scaling influence magnitude function, a weight editing influence range function, and a weight editing influence smoothness function.

Meanwhile, in another aspect of the present disclosure, there is provided an apparatus for providing a rigging tool, which comprises: an input unit configured to receive an input character; a generation unit configured to generate a basic rigging at the input character by using a skeleton extraction technique and a skinning weight technique; and a correction unit configured to provide a skeleton correction function and a skinning weight correction function on the basis of the generated basic rigging.

According to various embodiments of the present disclosure as above, a user may perform rigging fast by generating a basic rigging at an input character and giving a skeleton correction function and a skinning weight correction function thereto.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a flowchart for illustrating a method for providing a rigging tool according to an embodiment of the present disclosure.

FIG. 2 is a block diagram showing an apparatus for providing a rigging tool according to an embodiment of the present disclosure.

FIGS. 3 and 4 are diagrams for illustrating a method for providing a rigging tool according to an embodiment of the present disclosure.

FIGS. 5 to 9 are diagrams for explaining simulation results according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

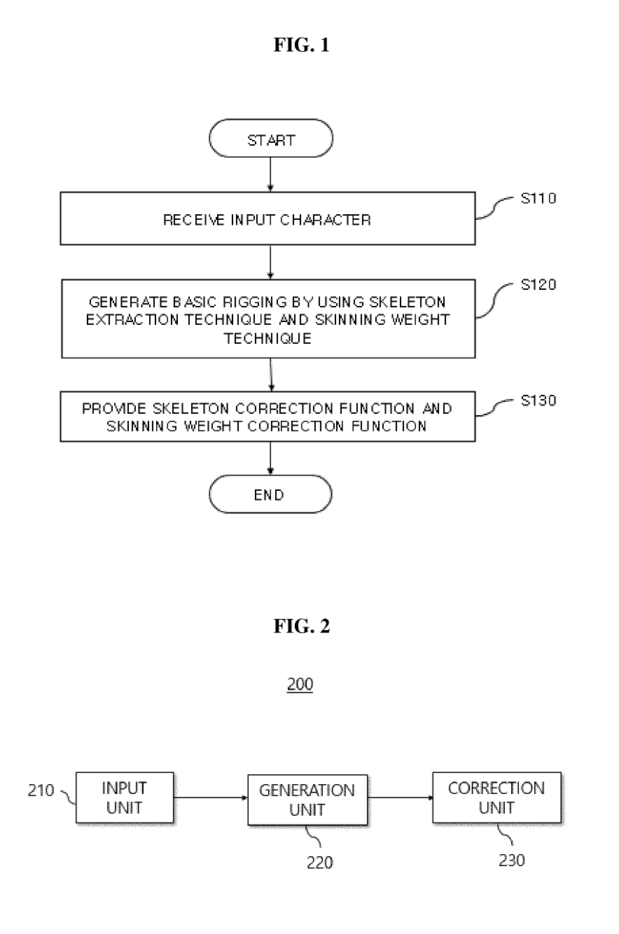

FIG. 1 is a flowchart for illustrating a method for providing a rigging tool according to an embodiment of the present disclosure.

Referring to FIG. 1, a method for providing a rigging tool according to an embodiment of the present disclosure includes receiving an input character (S110), generating a basic rigging at the input character by using a skeleton extraction technique and a skinning weight technique (S120), providing a skeleton correction function and a skinning weight correction function on the basis of the generated basic rigging (S130).

The skeleton extraction technique may generate a skeleton by compressing the input character into a zero volume and erasing a face. In this case, unnecessary portions in the generated skeleton may be removed using a Douglas-Peucker algorithm. Accordingly, it is possible to generate a basic rigging including only a required skeleton.

The skinning weight technique may calculate a skinning weight by using a heat diffusion weight. In this case, a skinning weight calculating equation to which the heat diffusion weight technique is applied is like Equation 1 below.

For every bone i: (H−L)wⁱ=Hpⁱ Equation 1
L: Laplacian matrix
H: Heat contribution matrix
wⁱ: Weight vector for bone i
pⁱ: Binary number (visible or not)

Hⱼⱼ=c/d²(j)
d(j): Distance from vertex j to nearest bone
c=1

Here, L is a Laplacian matrix, H is a heat contribution matrix, w is a weight vector, and p is a binary number.

In addition, the skinning weight technique may calculate a skinning weight by using a local computing region which calculates only a partial region of the character. In detail, when the basic rigging is corrected, the skinning weight should be calculated again in real time. At this time, since the skinning weight is calculated using the local computing region which calculates only a partial region of the character, the skinning weight may be calculated more rapidly. A skinning weight calculating equation to which the local computing region technique is applied is like Equation 2 below.

B(H−L)Awⁱ+B(H−L)B^{T}wⁱ=Hpⁱ Equation 2
L: Laplacian Matrix
H: Heat Contribution Matrix
wⁱ: Weight vector (in computing vertices) for bone i
pⁱ: Binary number (visible or not)
B: Matrix clipping computing vertices
A: Matrix clipping non-computing vertices

Hⱼⱼ=c/d(j)²
d(g): Distance from vertex j to the nearest bone
c=1

Here, L is a Laplacian matrix, H is a heat contribution matrix, w is a weight vector, p is a binary number, B is a matrix clipping computing vertices, and A is a matrix clipping non-computing vertices.

In addition, the skinning weight correction function may be provided by using at least one function selected from the group consisting of a weight scaling influence magnitude function, a weight editing influence range function, and a weight editing influence smoothness function.

In detail, in the weight scaling influence magnitude function, a user may control a weight intensity of a corresponding bone by using a controller to adjust a “c” value in c/d(j)² of an H matrix in Equation 2. The weight editing correction function may add one virtual bone at an existing bone location and control the added virtual bone to adjust a weight range by means of the virtual bone. Accordingly, in a state where the original bone location is fixed, the weight range may be adjusted by controlling only the virtual bone. The weight editing influence smoothness function may adjust “a” and “b” value in Equation 3 below, at which a bi-Laplacian matrix is added to the Laplacian matrix of Equation 2, to control smoothness of the weight.

$$( H - ( aL + {bL}^{2} ) {w}^{i} = {Hp}^{i} , \begin{matrix}a > 0 \\ b > 0 \\ a + b = 1\end{matrix} \\ L \text{:} Laplacian matrix \\ {L}^{2} \text{:} Bi \text{-} laplacian matrix \\ a \text{:} weight for laplacian matrix b \text{:} weight for bi \text{-} laplacian matrix \\ H \text{:} Heat contribution matrix {w}^{i} \text{:} Weight vector for bone i \\ {p}^{i} \text{:} Binary number ( visible or not ) \\ {H}_{jj} = c / {d ( j )}^{2} \\ d ( j ) \text{:} Distance from ver tex j to nearest vir tual bone \\ c = radius of bone \qquad Equation 3$$

Here, L is a Laplacian matrix, L² is a Laplacian matrix, H is a heat contribution matrix, a is a Laplacian matrix weight, b is a bi-Laplacian matrix weight, w is a weight vector, and p is a binary number.

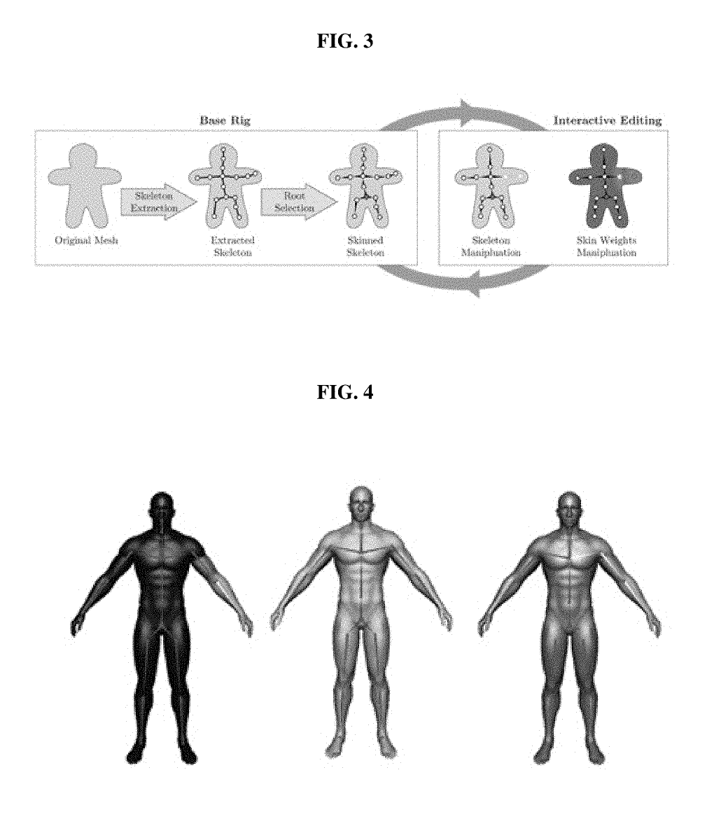

FIG. 2 is a block diagram showing an apparatus for providing a rigging tool according to an embodiment of the present disclosure.

Referring to FIG. 2, the apparatus 200 for providing a rigging tool includes an input unit 210, a generation unit 220 and a correction unit 230.

The input unit 210 may receive an input character, and the generation unit 220 may generate a basic rigging at the character input to the input unit 210 by using a skeleton extraction technique and a skinning weight technique.

The correction unit 230 may provide a skeleton correction function and a skinning weight correction function on the basis of the generated basic rigging.

FIGS. 3 and 4 are diagrams for illustrating a method for providing a rigging tool according to an embodiment of the present disclosure.

Referring to FIG. 3, a skeleton may be generated at the input character, a skinning weight is calculated to generate a basic rigging, and then the basic rigging may be corrected using a skeleton correction function and a skinning weight correction function.

Referring to FIG. 4, there is substantially no weight distribution, except for a skin weight corresponding to a left arm of a humanlike character at the left, and in this case, the skin weight is substantially not changed even though there is a correction. Therefore, like a humanlike character at the center, the skin may be divided into a partial region by using a mapping relation between the skeleton obtained during the skeleton extraction process and the skin, and then like a humanlike character at the right, only a region where the weight is greater than 0 on the basis of the corrected bone may be set as a local computing region. As a result, only a skin weight in a region including the corrected bone is calculated again, thereby reducing a rigging correction time and enhance the correction efficiency.

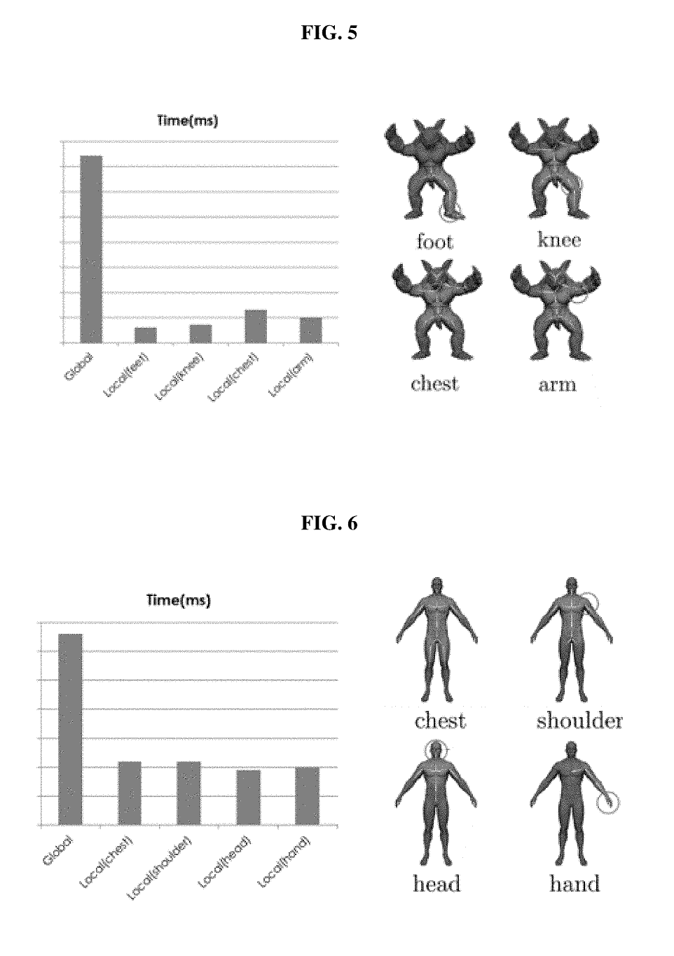

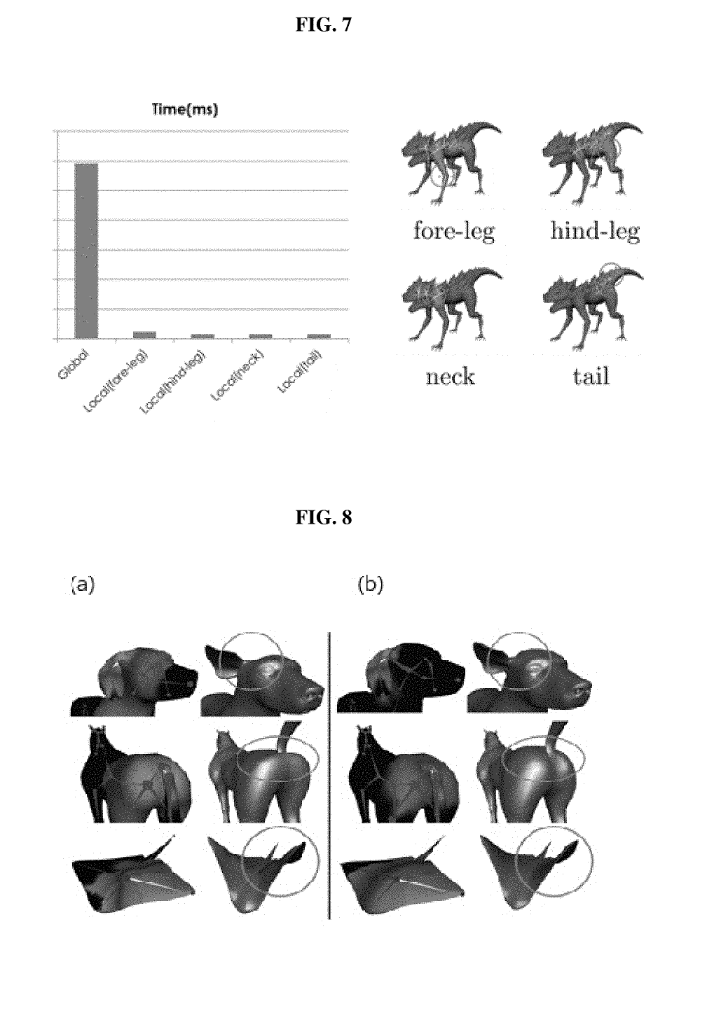

FIGS. 5 to 9 are diagrams for explaining simulation results according to an embodiment of the present disclosure.

Referring to FIGS. 5 to 7, it may be found that a calculation speed is increased if the local computing region is used, since the heat diffusion weight is calculated.

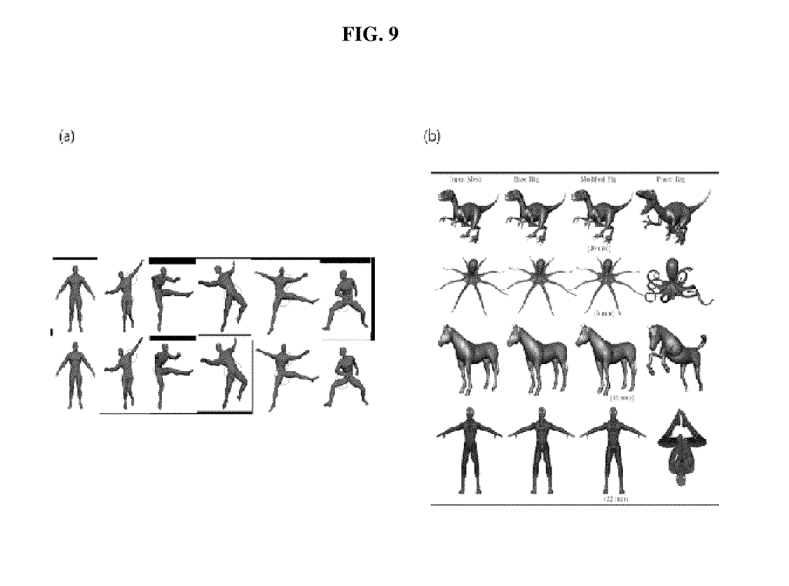

In addition, when an existing heat diffusion weight is calculated in FIG. 8(a), the shape of the character becomes unclear, but if the method for providing a rigging tool according to an embodiment of the present disclosure as shown in FIG. 8(b) is used, the shape of the character may be exhibited clearly.

Moreover, even though skilled animators and skilled artists have spent much time in the existing technique to generate a rigging as shown in FIG. 9(a), if the method for providing a rigging tool according to an embodiment of the present disclosure is used as shown in FIG. 9(b), a general user may easily perform rigging.

According to various embodiments of the present disclosure as described above, by generating a basic rigging at an input character and providing a skeleton correction function and a skinning weight correction function, a user may perform rigging in an easy and rapid way.

Meanwhile, the method according to various embodiments of the present disclosure as described above may be implemented as program codes stored in various non-transitory computer readable media and may be provided to each server or device in this state.

The non-transitory computer readable medium means a medium which may store data semi-permanently and be read by a device, rather than a medium storing data within a short time like register, cash, memory or the like. In detail, the various applications or programs described above may be provided in a state of being stored in a non-transitory computer readable medium such as CD, DVD, hard-disk, bleu-ray disk, USB, memory card, ROM or the like.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method for providing a rigging tool comprising:
receiving an input character;
generating a basic rigging at the input character by using a skeleton extraction technique and a skinning weight technique; and
providing a skeleton correction function and a skinning weight correction function on the basis of the generated basic rigging.

2. The method for providing a rigging tool of claim 1, wherein the skeleton extraction technique generates a skeleton by compressing the input character into a zero volume and erasing a face.

3. The method for providing a rigging tool of claim 2, wherein the skeleton extraction technique removes unnecessary portions from the generated skeleton by using a Douglas-Peucker algorithm.

4. The method for providing a rigging tool of claim 1, wherein the skinning weight technique calculates a skinning weight by using an equation, (H−L)wⁱ=Hpⁱ, where L is a Laplacian matrix, H is a heat contribution matrix, w is a weight vector, and p is a binary number.

5. The method for providing a rigging tool of claim 1, wherein the skinning weight technique calculates a skinning weight by using a local computing region which calculates only a partial region of the character.

6. The method for providing a rigging tool of claim 5, wherein the skinning weight technique calculates a skinning weight by using an equation B(H−L)Awⁱ+B(H−L)B^{T}wⁱ=Hpⁱ, where L is a Laplacian matrix, H is a heat contribution matrix, w is a weight vector, p is a binary number, B is a matrix clipping computing vertices, and A is a matrix clipping non-computing vertices.

7. The method for providing a rigging tool of claim 1, wherein the providing of a skinning weight correction function provides a skinning weight correction function by using at least one function selected from the group consisting of a weight scaling influence magnitude function, a weight editing influence range function, and a weight editing influence smoothness function.

8. An apparatus for providing a rigging tool comprising:
an input unit configured to receive an input character;
a generation unit configured to generate a basic rigging at the input character by using a skeleton extraction technique and a skinning weight technique; and
a correction unit configured to provide a skeleton correction function and a skinning weight correction function on the basis of the generated basic rigging.

9. The apparatus for providing a rigging tool of claim 8, wherein the skeleton extraction technique generates a skeleton by compressing the input character into a zero volume and erasing a face.

10. The apparatus for providing a rigging tool of claim 9, wherein the skeleton extraction technique removes unnecessary portions from the generated skeleton by using a Douglas-Peucker algorithm.

11. The apparatus for providing a rigging tool of claim 8, wherein the skinning weight technique calculates a skinning weight by using an equation (H−L)wⁱ=Hpⁱ, where L is a Laplacian matrix, H is a heat contribution matrix, w is a weight vector, and p is a binary number.

12. The apparatus for providing a rigging tool of claim 8, wherein the skinning weight technique calculates a skinning weight by using a local computing region which calculates only a partial region of the character.

13. The apparatus for providing a rigging tool of claim 12, wherein the skinning weight technique calculates a skinning weight by using an equation B(H−L)Awⁱ+B(H−L)B^{T}wⁱ=Hpⁱ, where L is a Laplacian matrix, H is a heat contribution matrix, w is a weight vector, p is a binary number, B is a matrix clipping computing vertices, and A is a matrix clipping non-computing vertices.
